(19) United States
(12) Patent Application Publication
(10) Pub. No.: US 2019/0155917 A1
(43) Pub. Date: May 23, 2019

(54) IMAGE-BASED DEDUPLICATION PROCESS FOR DIGITAL CONTENT

(71) Applicants: Daniel Felipe Lopez Zuluaga, New York, NY (US); Joseph DiTomaso, New York, NY (US)

(72) Inventors: Daniel Felipe Lopez Zuluaga, New York, NY (US); Joseph DiTomaso, New York, NY (US)

(21) Appl. No.: 15/815,878

(22) Filed: Nov. 17, 2017

(51) Int. Cl. G06F 17/30; G06K 9/46; G06K 9/00; G06F 17/18

(52) U.S. Cl. CPC G06F 17/3089; G06K 9/4671; G06F 17/18; G06K 9/00704; G06K 9/00691

(57) ABSTRACT

Provided are a system and method for performing image-based deduplication of web content. In one example, the method includes extracting image points from a first image associated with a first web page and image points from a second image associated with a second web page, determining image point pairings between the image points of the first image and the image points of the second image based on content included in the images, executing a regression operation on the image point pairs to determine which image point pairings are a match, and in response to an amount of matching image point pairings being greater than a predetermined threshold, determining the first image and the second image are captured of the same item, and transmitting information about the first and second images captured of the same item to an application.

### BACKGROUND

Various search engines provide services that compare web content from multiple websites. Often the same item is listed for purchase on multiple sites. Comparison websites typically collect web listings from multiple websites and databases and store the collected web listings in a database. Furthermore, the comparison site may generate a unified view of an item from content extracted from multiple different sites thereby providing a user with a comprehensive comparison of various attributes of the item, for example, price, availability, amenities, size, rooms, and the like, from the different sites. One industry where such comparisons often take place is in the retail industry where web visitors can filter and compare attributes of items offered for sale across different sites.

Retail websites may transmit a listing of items for sale to a comparison website system database where listings from multiple sites are accumulated for comparison. As another example, the comparison website system may crawl the websites on a periodic basis for web content included in the web listings. Here, the comparison website system or an agent thereof may scan retail web pages to retrieve product information such as features and prices and store the scanned information instead of relying on the retailer to provide such information. Additional approaches include receiving a data feed or a consolidated data feed of the web content from multiple websites including the product information, crowdsourcing data, and the like, and storing the web content in a centralized database.

One of the drawbacks of accumulating web content from multiple websites is that the web listings from different sites (and even the same site) can be duplicates. When combined, duplicate content creates redundant web listings of the same item resulting in an inefficient user experience. Therefore, comparison sites may attempt to remove duplicate content when possible. However, it is difficult to identify when two web listings are truly directed to the same item (e.g., product, service, lodging, travel itinerary, etc.) and not just a similar listing such as a same product but different model, a same hotel but different room, or the like. To make matters more difficult, two listings of the same item may have different content such as different views, missing information, different information, or the like, making it difficult to determine that two web listings are the same. Therefore, comparison sites often rely on a user to make a final determination based on their best judgment as to whether two web listings are indeed directed to the same item. However, what is needed is an automated system can accurately and reliable identify two web listings as being directed to the same item without the need for user intervention.

### SUMMARY

According to an aspect of an example embodiment, provided is a computing system that may include one or more of a network interface that may receive image data, and a processor that may extract image points from a first image associated with a first web page and image points from a second image associated with a second web page, determine image point pairings between the image points of the first image and the image points of the second image based on content included in the images, and execute a regression operation on the image point pairs to determine which image point pairings are a match. In this example, in response to an amount of matching image point pairings being greater than a predetermined threshold, the processor may determine that the first image and the second image are captured of the same item, and transmit information about the first and second images captured of the same item to an application.

According to an aspect of another example embodiment, provided is a computer-implemented method that may include one or more of extracting image points from a first image associated with a first web page and image points from a second image associated with a second web page, determining image point pairings between the image points of the first image and the image points of the second image based on content included in the images, executing a regression operation on the image point pairs to determine which image point pairings are a match, and in response to an amount of matching image point pairings being greater than a predetermined threshold, determining the first image and the second image are captured of the same item, and transmitting information about the first and second images captured of the same item to an application.

According to an aspect of another example embodiment, provided is a computing system that may include one or more of a network interface that may receive digital content of a plurality of web listings, each web listing representing an item and comprising a plurality of attributes associated with the respective item, and a processor that may receive a request to process a first item represented by a first web listing and a second item represented by a second web listing, detect an attribute of the first item that is missing from the first web listing, generate a substitute value for the missing attribute based on a value of one or more of other attributes of the first item included in the first web listing, and determine whether the first and second items are directed to a same item based on values of the attributes of the first item, including the inferred value, and values of the attributes of the second item. In this example, in response to determining the first and second items are directed to the same item, the processor may execute a deduplication operation based on the first and second web listings.

According to an aspect of another example embodiment, provided is a computer-implemented method that may include one or more of receiving digital content of a plurality of web listings, each web listing representing an item and comprising a plurality of attributes associated with the respective item, receiving a request to process a first item represented by a first web listing and a second item represented by a second web listing, detecting an attribute of the first item that is missing from the first web listing, and generating a substitute value for the missing attribute based on a value of one or more of other attributes of the first item included in the first web listing, determining whether the first and second items are directed to a same item based on values of the attributes of the first item, including the inferred value, and values of the attributes of the second item, and in response to determining the first and second items are directed to the same item, executing a deduplication operation based on the first and second web listings.

Other features and aspects may be apparent from the following detailed description, the drawings, and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings. Furthermore, the drawings include photographs because the photographs are the only practicable medium for illustrating the image matching.

FIG. 1 is a diagram illustrating a system for aggregating web content in accordance with an example embodiment.

FIG. 2 is a diagram illustrating a process of determining whether images are directed to a same item in accordance with an example embodiment.

FIG. 3 shows photographs illustrating a scale-invariant feature transform (SIFT) image matching process in accordance with an example embodiment.

FIG. 4 shows photographs illustrating a SIFT image matching process in accordance with another example embodiment.

FIGS. 5A and 5B are diagrams illustrating a random sample consensus (RANSAC) regression model in accordance with example embodiments.

FIG. 6 is a diagram illustrating a web listing inventory deduplication process in accordance with an example embodiment.

FIG. 7 is a diagram illustrating a process of inferring a missing attribute of a web listing in accordance with an example embodiment.

FIG. 8 is a diagram illustrating a model of attributes for a property rental listing in accordance with an example embodiment.

FIG. 9 is a diagram illustrating a method for matching images of a same item in accordance with an example embodiment.

FIG. 10 is a diagram illustrating a method for performing deduplication of web listings in accordance with an example embodiment.

FIG. 11 is a diagram illustrating a computing system in accordance with example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a deduplication system for web-based digital content. Furthermore, the system may also determine when images of two or more items which include different digital content are actually images of the same item (e.g., a lodging accommodation, a product, a person, etc.) Comparison websites and other data matching technologies often aggregate web content from multiple websites and provide a user with a comprehensive listing of web content. Data deduplication is a data compression process which may match duplicate copies of repeated data such as duplicate web listings. In the deduplication process, web listings may be processed to identify web listings that are a match to one another. Often a stored web listing or master copy is compared to a newly received web listing. When a match occurs, the redundant web listing may be replaced with a small reference (e.g., bit value, pointer, URL, etc.) that points to the web listing, rather than storing a duplicate copy of the web listing and its images, description, reviews, etc. within a storage inventory (e.g., a file, a table, a data store, a database file, etc.) Because the same web listing may occur dozens or even hundreds of time, the amount of data that is stored and maintained may be greatly reduced by deduplication. When a subsequent search is performed, only a single web listing may be provided which is used to represent a group of duplicate web listings which can be found across multiple sites.

Web listings are often used to represent an item such as a product or service. For example, the item may refer to a lodging accommodation (e.g., a hotel room, a vacation home rental, a train cabin, a cruise cabin, etc.) or it may refer to an item such as a product, a service, and the like. Web listings may include digital content such as images, textual description, input fields, boxes, tabs, other selections, and the like. When a comparison website or a search engine provides an aggregate of search results or provides a comparison of web content (e.g., price, criteria, availability, description, images, etc.) for a same product (and brand) from across multiple sources, it may be desirable to reduce or eliminate search results (and digital content) for redundant listing from the aggregate or only provide a subset of the search results such that the combined search results are more efficient for the user to navigate through. In some cases, digital content from duplicate web listings may be aggregated by the comparison site when generating a single representative web listing.

For example, a comparison website host server may receive search results corresponding to a same rental property (e.g., lodging) from multiple website and consolidate the search results into a single search result for that accommodation rental property which provides a comparison of different content such as price, features, availability, and the like. As another example, the comparison site may only extract some content from a plurality of search results corresponding to the same item from across multiple websites (e.g., price for an item on multiple sites, availability of item from multiple sites, etc.) while eliminating the rest of the content.

The example embodiments include a system which significantly improves accuracy of matching web listings (e.g., search results) with one another by implementing an image matching process which determines whether two images (e.g., from two web listings) are of the same item by executing a combination of scale-invariant feature transform (SIFT) and random sample consensus (RANSAC) operations on the two images. Accordingly, two images can be identified as being of the same item even when the two images may have a different size, focus, resolution, view angle, and/or the like. The image processing results may be used to further enhance the determination of the deduplication process thereby ensuring more accurate results when determining whether two web listings are duplicates.

The example embodiments also include a system which significantly improves accuracy of a deduplication process when one or more of the web listings are missing an attribute used for matching. As an example, an accommodation listing (e.g., vacation home, hotel, etc.) may include various attributes such as bedrooms, bathrooms, occupancy rules, geographic location, and the like, which should be the same at each website on which the accommodation is listed regardless of other features of the listing such as a description, images, reviews, property name, or the like, which tend to differ from website to website. These attributes can be used to determine when two accommodation listings are duplicates of one another. However, often one or more of these attributes are missing from the digital content. The example embodiments provide a learning system that can generating a value for the missing attribute based on the training of a random forest model.

According to various aspects, the image matching and deduplication process may be performed by a search engine or other type of comparator. For example, a user may input a search query into a search engine in order to search for web content associated with real property such as a home, a hotel, a motel, a restaurant, an office, a building, an apartment, a cruise, a train, and the like. When the search engine performs a search for available accommodation listings matching the user's search query, the search may be performed across multiple sites. As a result, multiple search results corresponding to the same lodging/accommodation may be collected. Therefore, it may be desirable to reduce the multiple search results into a single search result or reduce the content of the multiple search results into a consolidated search result providing information from multiple sites.

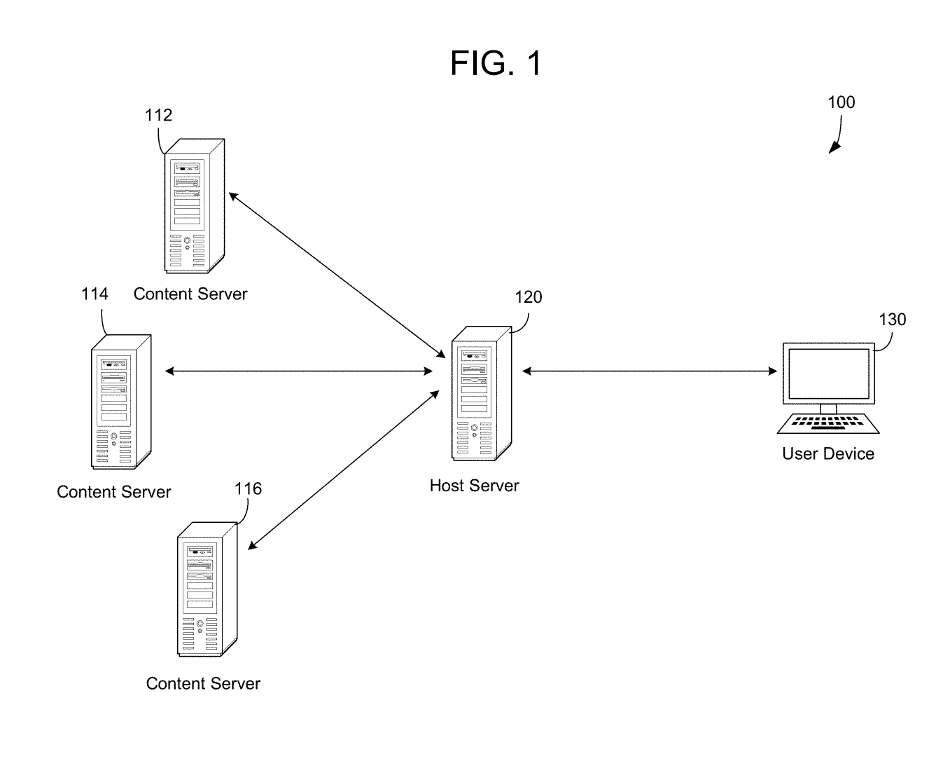

FIG. 1 illustrates a system 100 for performing deduplication of web content in accordance with an example embodiment. Referring to FIG. 1, the system 100 includes a plurality of content servers 112, 114, and 116, a host server, and a user device 130, which may be connected to each other via a network such as the Internet, a private network, or the like. In some embodiments, the content servers 112, 114, and 116 may be web servers that host respective websites offering listings of items for purchase, and the host server 120 may be a host of a comparison website. However, the embodiments are not limited to this example. As another example, the content servers 112, 114, and 116 may be databases, servers, cloud storage, and the like.

Meanwhile, the user device 110 may be a computer, a mobile device, a smart wearable device, a tablet, an appliance, a kiosk, and the like. In the example of FIG. 1, the host server 120 may host a web site such as a search engine, a comparison site, a content providing site, and the like, and the user device 110 may connect to the host server 120 by entering a web address (e.g., URL, URI, etc.) through a web browser installed on the user device 110. In addition, the host server 120 may collect web content from the content servers 112, 114, and 116 (e.g., from websites hosted by the content servers 112, 114, and 116). For example, the host server 120 may collect digital content of web listings (e.g., search results) which include travel related content, news related content, entertainment content, and the like, from across the multiple content server 112, 114, and 116. For example, the host server 120 may perform a periodic crawl for the content or periodically receive content from the content servers 112, 114, and 116. For convenience of explanation, some examples herein refer to travel related web content such as hotel rentals, vacation home rentals, flights, and the like, however, it should be appreciated that other types of web content may be used such as retail web content, news content, medical content, entertainment content, and the like, without any difference in the system and methods.

As an example, the user device 130 may submit a query to the host server to search for an item such as a lodging accommodation in a specific geolocation (e.g., town, city, zip code, state, etc.). The host server 120 may extract search results from different websites hosted by the content servers 112, 114, and 116, and provide a comparison of the results via a user interface. The search results may be extracted from web listings included in an inventory of web listings stored in a database associated with the host server 120. The database may be updated on a periodic basis from the actual live website data included on websites hosted by the content servers 112, 114, and 116. The search results may include web listings of items that are found as a result of the query. The items in this example may include lodging such as hotels, vacation home rental property, and other types of accommodations. The web listing for each lodging result may have digital content that includes one or more of a name, a geolocation, and images of the lodging, as well as other attributes such as rating, description, amenities, bedrooms, bathrooms, maximum occupancy (i.e., sleeps), travel directions, etc.

Prior to outputting the search results, a deduplication operation may be executed by the host server 120 to reduce the amount of duplicate search results which are provided to the user device 130. For example, the host server 120 may generate a master list or an aggregated list of search results that are combined from multiple web sites and perform deduplication of the search results to remove redundant search results. In this case, if a search result from the first web site is to the same item as a search result of the second website, the search result from the second website can be determined as being a redundant search result of the first website, and be removed from the aggregated list of search results and replaced with a pointer, etc. Furthermore, the aggregated list of search results with redundant search results removed may be output from the host server 120 to a display of the user device 130.

The comparator website may be used to compare the search results of an item from many websites simultaneously. The comparator website may provide for a visual comparison of items as well as attributes of the items. For example, a user can search websites for finding the cheapest price on books, cars, hotels, consumer electronics, services, and the like. In the field of lodging accommodation such as hotels, vacation rentals, and the like, the comparator website may extract digital web content of an item from multiple sources and aggregate the web content, for example, prices, specials, discounts, availability, etc., of that item (e.g., hotel room, rental home, etc.) and provide the content into a unified page, format, layout, and the like. As an example, the Waldorf Astoria may be listed as hotel #1234 on hotels.com and be listed as hotel #5678 on hotwire.com. Using these product codes as pointers, the central database may combine the data from multiple sites into a single comparison site giving the reader multiple prices for a single item.

Typically, however, hotels on two different sites are compared to each other through a manual inspection process by an operator to determine if they are in fact a listing of the same rental property. That is, when you have the same lodging accommodation listed on different websites, there is a manual mapping of the lodging accommodation via the comparison search site. The reasons for this is that hotels, vacation homes, and other lodging accommodations are often not matched perfectly between different websites. For example, however slight, the name of the hotel/home may be listed differently on different websites such that a perfect match between names is not possible. As another example, an address of the hotel/home or a geo-location of the hotel/home may not be an exact match between two websites. Therefore, automatic comparison of lodging accommodation listings based on the listed web content may be fraught with mistakes. To make matters even more difficult, often information about the hotel or rental property is missing.

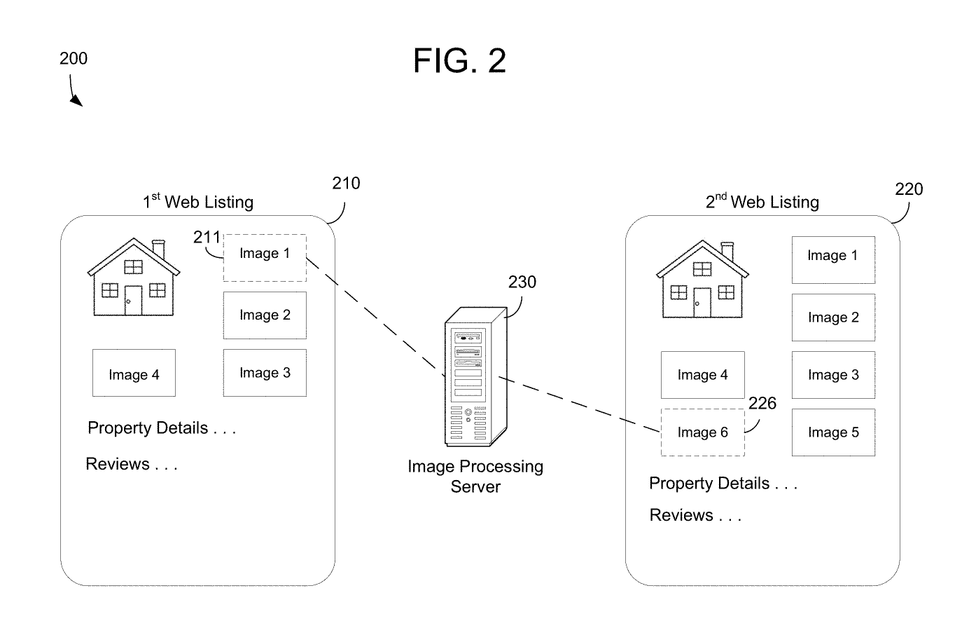

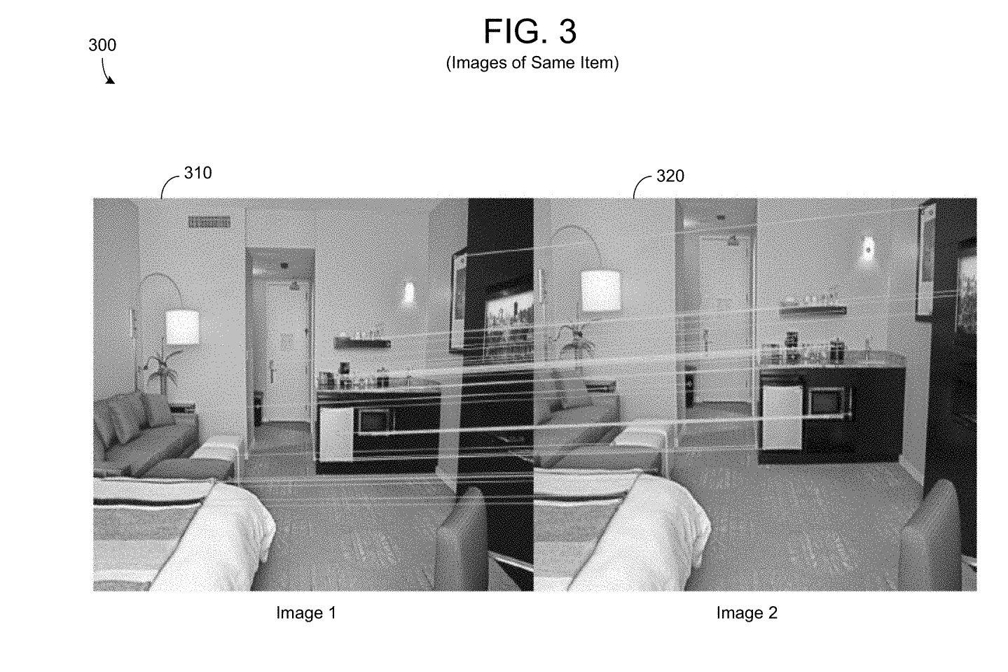

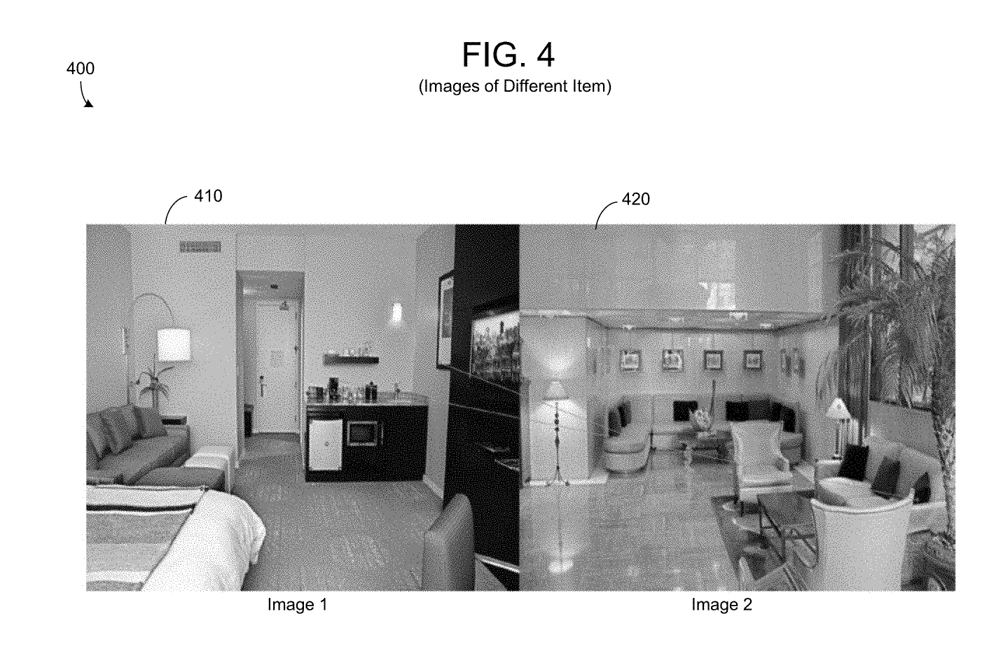

FIG. 2 illustrates a process 200 of determining whether images are directed to a same item in accordance with an example embodiment. The image matching process described herein may be used as part of a larger deduplication process for web listings such as lodging accommodations. The image matching process includes multiple steps. In a first step, SIFT descriptors are identified from each image and matched together to identify candidate image point pairings. These examples are shown in FIGS. 3 and 4. The second step of the image matching process includes executing a RANSAC regression operation on the candidate SIFT descriptor pairings between the two images to enhance the accuracy (and filter out noisy detection) in the SIFT image pairing process, in step 1. The multi-step process results in a highly accurate image matching process even when images have different angles, illumination, scale, or the like.

Referring to FIG. 2, a first web listing 210 and a second web listing 220 are being compared to one another by an image processing server 230 which may correspond to the host server 120 shown in FIG. 1. Here, images are displayed as thumbnails in the first web listing 210 and the second web listing 220. The web listings 210 and 220 also include additional information such as property details, reviews, a number of bedrooms, a number of bathrooms, maximum number of occupants, star ratings, and the like. Each web listing may be associated with different respective websites and may be spread across multiple web pages of the respective websites.

The process 200 may be used to determine whether an image has been captured of the same item such as images of a same piece of rental property (e.g., a room, etc.) of the same piece of lodging/property, and the like. In this example, the process 200 is used to determine if image 211 of the first web listing 210 and image 226 of the second web listing 220 are images captured of a same lodging accommodation such as a same living room, a same hotel room, a same bathroom, a same dining room, a same kitchen, a same exercise room, a same pool, or the like. As will be appreciated, images of a room may be taken at different angles, different fields of view, different resolutions, and the like. Furthermore, resulting images may have different sizes, different objects, and the like. The process 200 may be used to determine whether two images are directed to the same item especially in a case where the images are not perfect matches to one another.

FIG. 3 illustrates a SIFT image matching process 300 which may be performed by the image processing server 230 during the process 200 in FIG. 2, in accordance with an example embodiment. In this example, the image matching process 300 determines that a first image 310 (e.g., photograph) and a second image 320 are possible images of the same item (i.e., room) even though the images are not identical. For any object in an image, interesting points on the object can be extracted to provide a feature description of the object by the SIFT operation. This description, extracted from the first image 310, can then be used to identify the object when attempting to locate the object in the second image 320 containing many other objects. To perform reliable recognition, the features extracted from the first image 310 should be detectable in the second image 320 even under changes in image scale, noise and illumination. Such points usually lie on high-contrast regions of the image, such as object edges. SIFT can robustly identify objects even among clutter and under partial occlusion, because the SIFT feature descriptor is invariant to uniform scaling, orientation, illumination changes, and partially invariant to affine distortion.

In the process 300, SIFT keypoints of objects may be extracted from one of the images (e.g., image 310) and stored in a database or file. An object may be recognized within the other image (e.g., second image 320) by individually comparing each feature detected from the second image 320 to this database and finding candidate matching features between the first and second images 310 and 320 based on Euclidean distance of their feature vectors. From the full set of matches, subsets of keypoints that agree on the object and its location, scale, and orientation in the second image are identified to filter out good matches. The determination of consistent clusters may be performed rapidly by using an efficient hash table implementation of the generalized Hough transform. Each cluster of three or more features that agree on an object and its pose may then be subject to further detailed model verification and subsequently outliers are discarded. Next, the probability that a particular set of features indicates the presence of an object is computed, given the accuracy of fit and number of probable false matches. Object matches that pass all these tests can be identified as correct with some probability.

In the example of FIG. 3, the lines between the first image 310 and the second image 320 indicate matching pairs of keypoints between the two images. The keypoints include a descriptor and a reference location value which includes an X-axis coordinate and a Y-axis coordinate which represents the point of the keypoint. Keypoints may be assigned based on locations and at particular scales and orientations. The keypoint descriptor includes a descriptor vector for each keypoint such that the descriptor is highly distinctive and partially invariant to the remaining variations such as illumination, 3D viewpoint, etc. This keypoint descriptor detection may be performed on the image closest in scale to the keypoint's scale.

During the SIFT operation being executed in the process 300, a predetermined amount of SIFT descriptors may be identified from each image (e.g., 50, 75, 100, 200 etc.). The number of SIFT descriptors identified from each image is configurable. Next, the process 300 determines how many SIFT keypoints in the first image 310 are a candidate match with SIFT keypoints in the second image 320. When the amount of SIFT keypoint pairs between the first image 310 and the second image 320 is above a threshold amount (e.g., 3 or more) the process 300 may determine to execute step two of the image process. However, as shown in FIG. 4, when a first image 410 and a second image 420 include less than a predetermined amount of candidate matching SIFT keypoints, the process may end.

However, performing the image matching process with the SIFT operation alone in step one does not provide a high level of accuracy due to the amount of noise within the images that are being matched. The cause of this is that images (e.g., images captured and posted on listings on different websites) are often taken at different angles, different sizes, different zoom, etc. Therefore, the example embodiments further enhance the SIFT operation by incorporating a RANSAC regression. The SIFT operation results in SIFT descriptors having many matching key points as a result of noise matching, not the same images. To get rid of the noisy matches, RANSAC regression may be used in the second step of the image matching process to further refine the matching key points (e.g., at least three key points on the RANSAC line).

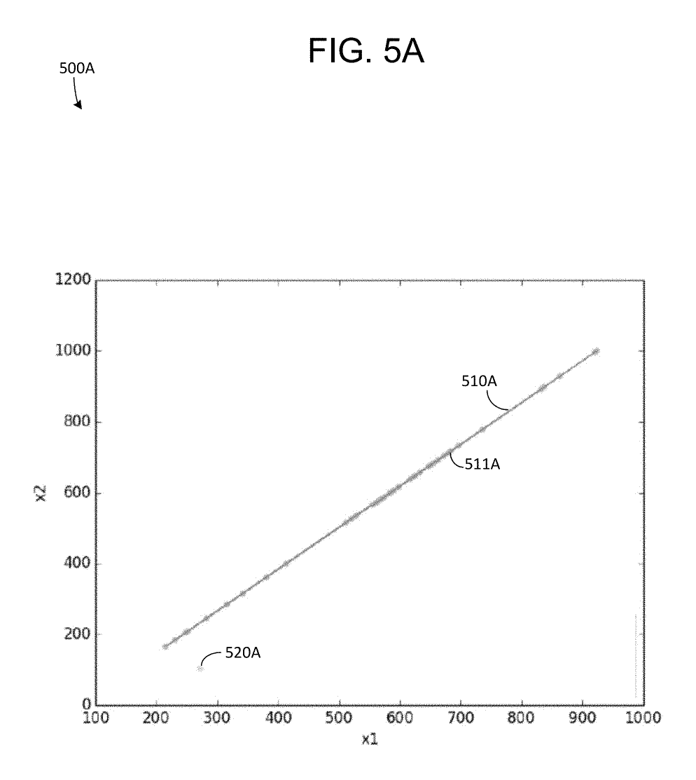

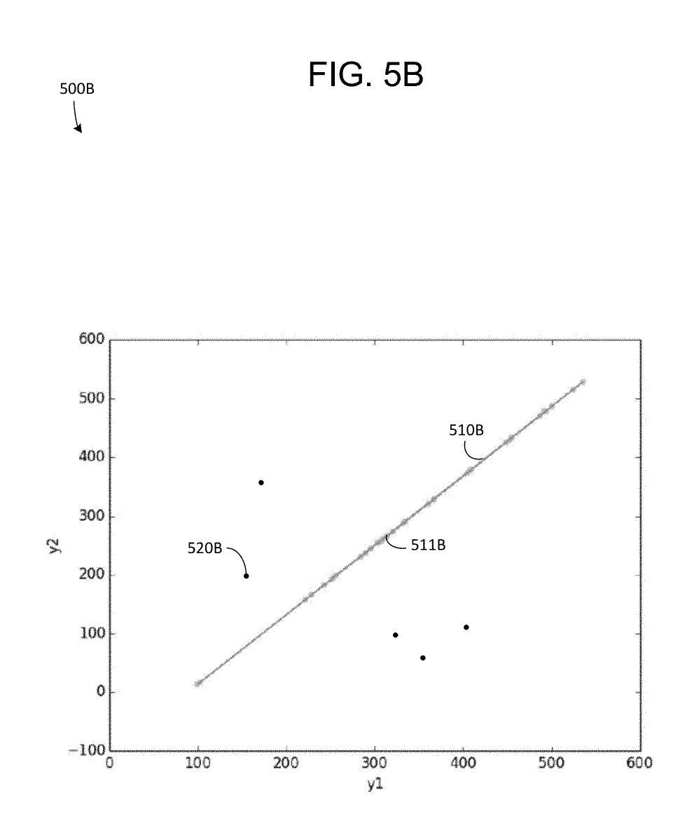

FIGS. 5A and 5B are diagrams illustrating a RANSAC regression model being performed on SIFT keypoints in accordance with example embodiments. Referring to FIG. 5A a RANSAC regression operation 500A is executed on the X axis coordinates of SIFT keypoint pairings between the first image 310 and the second image 320 to generate a RANSAC line 510A. Meanwhile, in FIG. 5B, a RANSAC regression operation 500B is executed on the Y axis coordinates of the SIFT keypoint pairings between the first image 310 and the second image 320 to generate a RANSAC line 510B. According to various aspects, one of the X axis and the Y axis may be analyzed via RANSAC regression, or both the X axis and the Y axis may be independent analyzed via RANSAC regression and combined to determine an overall level of matching between the first image 310 and the second image 320. By using both X axis and Y axis, a further level of accuracy can be provided.

Executing the RANSAC operation 500A generates a RANSAC line 510A. Each of the X coordinates of the candidate SIFT keypoint pairings may be then be modeled on the graph and compared to the RANSAC line 510A. Based on a location of the modeled keypoint pairing with respect to the RANSAC line 510 is used to determine by the RANSAC operation whether the keypoint pairing is an inlier 511A or an outlier 520A. Meanwhile, executing the RANSAC operation 500B generates a RANSAC line 510B. Each of the Y coordinates of the candidate SIFT keypoint pairings may be then be modeled on the graph and compared to the RANSAC line 510B. Based on a location of the modeled keypoint pairing with respect to the RANSAC line 510B is used to determine by the RANSAC operation whether the keypoint pairing is an inlier 511B or an outlier 520B.

The RANSAC operation may determine whether the first and second images are truly a match based on the ratio of outliers/inliers for the X coordinate RANSAC operation and/or the Y coordinate RANSAC operation. RANSAC can be beneficial when there is a set of points that form a line and also outliers (most of points clustered around some line but some points that are outliers). The RANSAC operation may obscure the outliers and finds a line through the random samples that gets rid of the outliers and that corresponds to the inliers (i.e., true matches). The RANSAC line goes through the points that match well which in the case are image keypoints.

According to various aspects, during the first step of the image process, the top SIFT keypoints for each image (e.g., top 100 keypoint descriptors) may be assigned by the process 300 to each of the first image 310 and the second image 320. That is, the SIFT operation may identify keypoint descriptors in image 310 that are potentially matches to keypoint descriptors in image 320. Each descriptor in the SIFT keypoint pair has X and Y coordinates (and possible Z if it's a three-dimensional image). Accordingly, in step two, at runtime, two regressions may be performed on the SIFT keypoint pairings. For example, a regression operation for the X axis coordinates of the keypoint pairs between images and a regression operation for the Y axis coordinate of the keypoint pairs between images.

As a non-limiting example, descriptor 1 of an image A can be determined as a candidate match for descriptor 3 from an image B. Next, the process may extract X and Y coordinates of descriptor 1 from image A and X and Y coordinates of descriptor 3 from image B, and plot two different regression lines one for X1 and X2, and another one for Y1 and Y2. Next, the RANSAC regression of both lines is performed and the results are added together to find the intersection. The resulting RANSAC points that are inliers in both regressions X and Y provides a counter for the algorithm. It is possible to determine a true match when the number of RANSAC inliers is at a predetermined threshold in both X and Y operations (e.g., 40%, 50%, etc. of the top 100 descriptors) being a match. As another example, it may be assumed that when two images have at least three descriptors which match then the two images are the same.

The image matching process involving both SIFT descriptors and RANSAC regression operations, may be customized for specific rooms or items being displayed within the images. For example, when the web listings correspond to vacation rentals, the SIFT/RANSAC regression model can be custom trained for different rooms on a property such as living rooms, kitchens, bedrooms, bathrooms, etc. For each image (e.g., images 310 and 320 shown in FIG. 3) a URL may be provided and the server may download every image at that URL and extract SIFT descriptors from the images and store the descriptors. The images may be stored in association with the web listing/URL for the images. During a deduplication operation, for every pair of web listings, the SIFT/RANSAC analysis can be performed to determine how many duplicate images there are between the two web listings. For this step, the system may download all images and codify the images for processing. The number of duplicate images between two listings may be used to determine whether two listings are in fact directed to the same item.

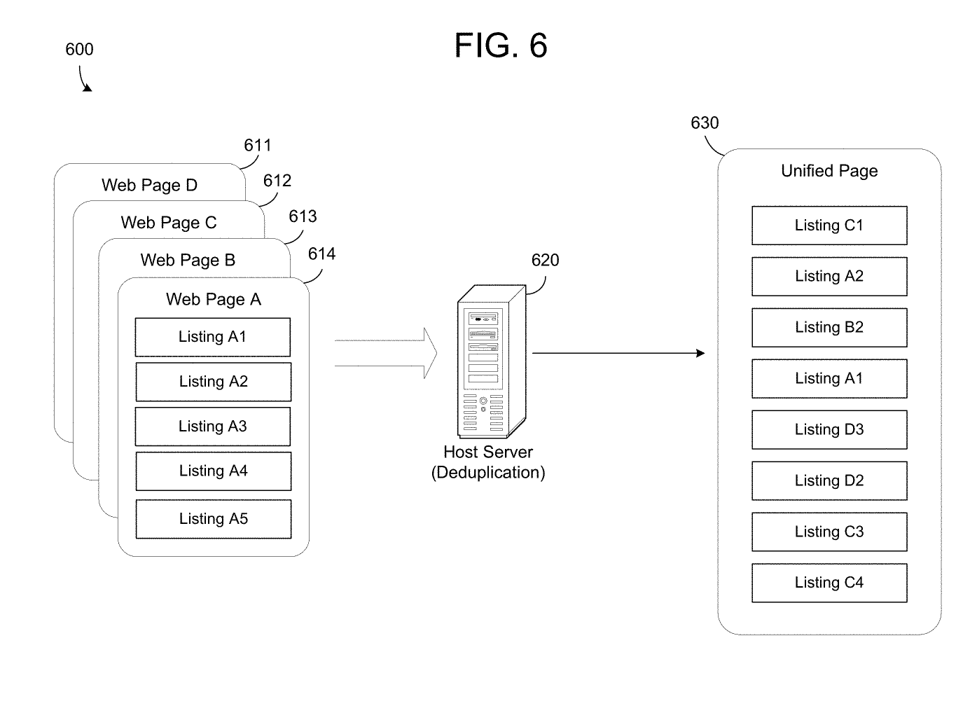

An example of a deduplication process 600 is shown in FIG. 6. The deduplication process 600 may be performed by a host server 620 which attempts to identify as many duplicate web listings as possible from across different websites 611, 612, 613, and 614. By identifying two web listings as being a match, the deduplication process can perform a number of steps. For example, the deduplication process may remove the duplicate. As another example, the deduplication operation may aggregate digital content from duplicate listings (i.e., listings of a same item) to create a combined record for the listing or otherwise point to each other. As another example, the deduplication operation may output the matching listings (e.g., when the listings are for different organizations, etc.) to enable a larger record of the listing for each organization. In this example, one listing may be from a first provider having first data, and the other listing may be from a second provider having different data. By matching the two listings, the data associated with that listing/inventory may be expanded by including any data from the second data that is not included in the first data.

Referring to FIG. 6, the process 600 performs a deduplication operation on web listings (e.g., vacation/property rental listings). A central server or a comparison website host server may collect web listings from a plurality of websites and store a very large database of web listings (e.g., vacation rentals). The process 600 identifies pairs of web listings that are a possible match, and then determines whether the pairs are the same listings or whether they are different listings based on a machine learning process which can be trained using a random forest. As a result, listings for the different web pages 611, 612, 613, and 614, may be matched together to form with duplicate listings removed (and only a pointer remaining, etc.) on a unified page 630 by the host server 620.

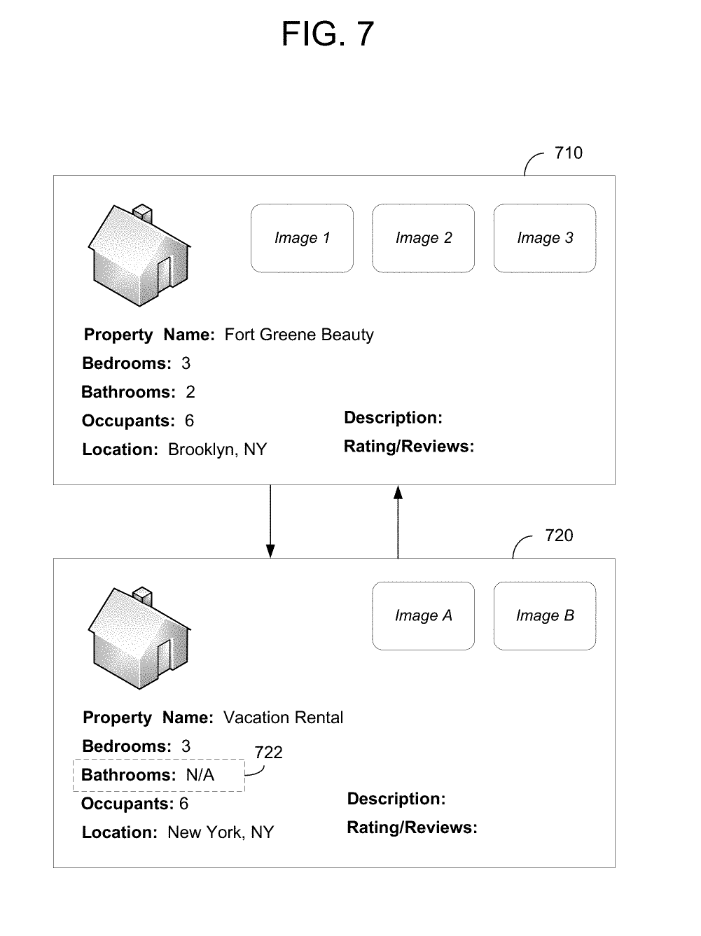

FIG. 7 illustrates an example of digital content that is included in a web listing 710 which is directed to an item (e.g., a vacation rental property). In this example, the web listing 710 includes a plurality of attributes which may include a geographical location (latitude/longitude coordinates), images of the property, name of the property, amenities Wi-Fi, parking, pool, min/max prices, description, ratings/reviews, number of rooms, number beds, and the like. According to various aspects, the host server 620 shown in FIG. 6, or another computing system, may collect many web listings of many vacation rental properties (or other items for purchase/rent) and generate a machine learning model that can be used to identify a correlation between the different attributes of the web listing. For example, the host server 620 may build an ensemble learner (e.g., a random forest) during a training phase based on the collected web listings and the respective attributes of the web listings. Accordingly, when a web listing (e.g., web listing 720) is collected that is missing one or more attributes, the host server 620 may infer or otherwise determine a substitute value for the missing attribute based on the ensemble learner that is trained based on attributes of previously received web listings.

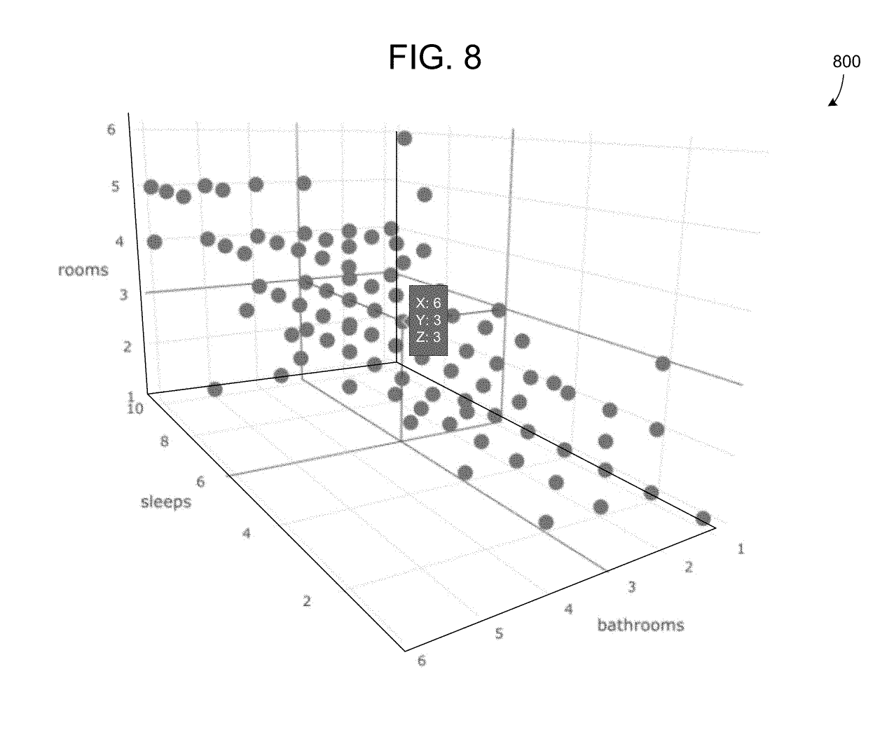

An example of the training data is shown in the visual representation 800 of FIG. 8 where attributes for bedrooms, bathrooms, and maximum occupants are modeled together on a multi-dimensional graph. The host server 620 may generate a training set based on attributes of previously collected web listings to train the random forest model. The host server 620 may then use the random forest model to determine a missing attribute for a web listing to further define the attributes of the web listing for comparison with other web listings during a deduplication operation such as shown in FIG. 6. For example, referring again to FIG. 7, the random forest model may be used to infuse a missing attribute 722 of the web listing 720 with supplemental data based on the previously collected web listings. Based on the infused data, during a deduplication operation the host server 620 may determine that the web listing 710 and the web listing 720 are actually directed to a same vacation rental property even though a number of attributes are not perfect matches such as location, property name, images, description, ratings, etc.

The system may also implement functions to reduce the initial amount of web listings for comparison with a target web listing during a deduplication operation. For example, location distance can be used to reduce the number of pair comparisons. As another example, amenities may be compared to generate a score indicating the likelihood in which the two properties are a match. It's a brute force comparison that is reduced based on additional data. For each pair of listings, algorithms may be performed. These are the variables that are used for each pair of listings.

The random forest may be used to predict missing attributes and infuse the predicted values into the missing attributes (i.e., the missing data) of a web listings. As a result, holes or gaps in a web listing may be filled with supplemental data. The random forest may use linear models as shown in 800 of FIG. 8, and use a linear model function in order to predict a missing attribute. For example, if the number of rooms of a vacation rental property is missing, the random forest may be used to predict the number of rooms based on a number of bathrooms and number of sleeps, of the vacation rental. As another example, if the number of bathrooms is missing, the number of rooms and the number of sleeps can be used to predict the number of bathrooms. As another example, if the number of sleeps is missing, the number of rooms and the number of bathrooms can be used to predict the number of sleeps. In an example in which both the number of rooms and bathrooms is missing, the system can predict the number of rooms and bathrooms from the number of sleeps based on linear models. As another example, when a listing is missing all three of these values, the system can predict the number of rooms based on the average number of rooms in local locations within a particular radius. By predicting/infusing a missing attribute into a web listing, a better and more accurate comparison can be made by the host server when performing a deduplication operation.

According to various embodiments, the host server 620 may extract attributes from digital content of a web listing. The host server 620 may extract any of the attributes and store them together with an identification of the web listing (e.g., URL) as a record in a database or spreadsheet which is automatically populated by the host server 620. Here, the records may be stored in tabular format with rows and columns of data which are dedicated to the different attributes of the item associated with the web listing. For example, a rental property will have different attributes than an automobile, etc. The host server 620 may fill-in each record using attribute data extracted from the digital content of a web page and also supplement one or more missing attribute values using inferred/infused data that is determined based on the random forest operation being executed by the host server 620. Accordingly, the host server 620 may fill-in missing data of a record using supplemental data that is generated by the random forest modeling operation. The database may also include a master list of records by which a deduplication operation is performed. Each record of the master list may be compared or paired with newly received web listings collected by the host server 620 purposes of deduplication/linking.

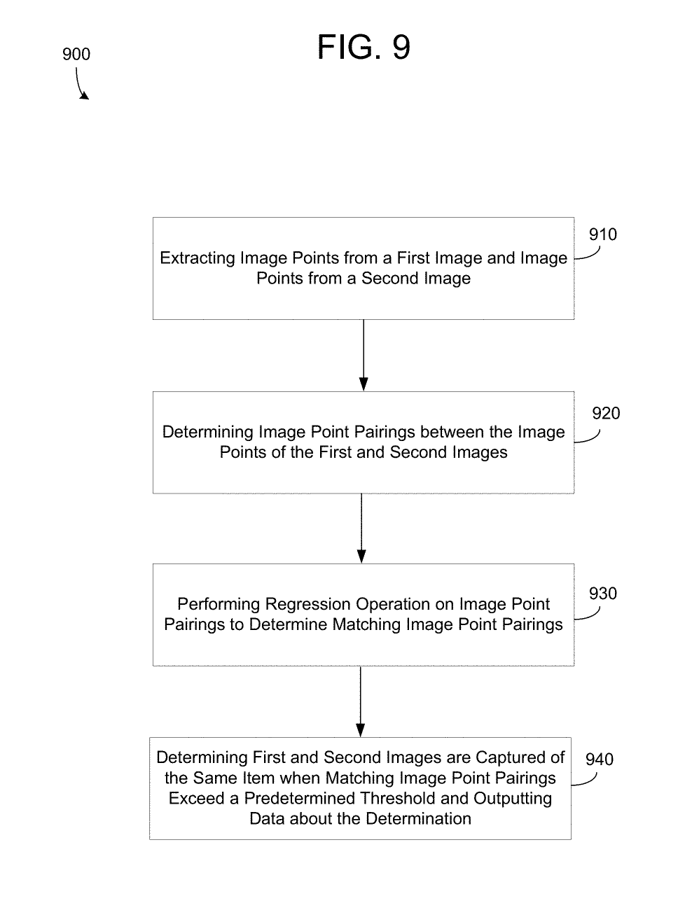

FIG. 9 illustrates a method 900 for matching images that correspond to a same item in accordance with an example embodiment. For example, the method 900 may be performed by a web server, a database, a cloud platform, or another type of computing system or combination of systems. Referring to FIG. 9, in 910 the method includes extracting image points from a first image associated with a first web page and image points from a second image associated with a second web page. For example, the first and second images may be included in web listings included in the first and second web pages, respectively. The images may be captured of an item that is posted for sale such as a product, a service, a hotel rental, a vacation rental property, a cruise ship rental, an airline ticket, a train ticket, a rental car, and the like. In an example in which the images are associated with a rental property, the image may be captured of at least one of a room, a building, a pool, and a common area, which are included in a property rental listing of a web page.

In 920, the method includes determining image point pairings between the image points of the first image and the image points of the second image based on content included in the images. For example, the determining image point pairings may include executing a SIFT operation to detect the image point pairings between the first and second images. Each SIFT image point may include a descriptor as well as coordinates (e.g., X axis, Y axis, etc.) of the image point on the screen. The SIFT operation may identify SIFT points in each image which are correspond to one another based on an initial estimation. Here, the SIFT operation may not be very accurate (e.g., 40% accuracy) even when the two images correspond to the same item. The lack of accuracy can be due to a number of factors such as different views of the same item, different zooming, different coloring, different resolution, different image size, and the like.

Therefore, in 930, the method may include performing a regression operation on the image point pairs to determine which image point pairings are a match. By performing a regression operation on the image point pairs, a greater level of accuracy can be achieved. The regression operation may include executing a RANSAC operation on the SIFT detected image point pairings to determine which SIFT detected image point pairings are inliers and which SIFT detected image point pairings are outliers. In some embodiments, separate RANSAC operations may be executed for X coordinates and Y coordinates, respectively, of the SIFT detected image point pairings and combining results of the separate RANSAC operations to determine which SIFT detected image point pairings are inliers and which SIFT detected image point pairings are outliers.

In response to an amount of determined matching image point pairings being greater than a predetermined threshold, in 940 the method may include determining the first image and the second image are captured of the same item, and transmitting information about the first and second images captured of the same item to an application. As an example, in response to an amount of SIFT detected image point pairings being determined to be inliers exceeding the predetermined threshold, the determining may determine that the first and second images are captures of the same item. In some embodiments, the method may further include executing a de-duplication operation on the inventory of web listings based on determining that the first and second item listings include images that are captured of the same item. Here, the de-duplication operation may remove one or both of the first and second web listings from the inventory to reduce a search space of items when a search query is input and processed based on the inventory of web listings. In this example, the first image may be incorporated in a first item listing on the first web page and the second image may be incorporated in a second item listing on the second web page, which are stored in an inventory of item listings.

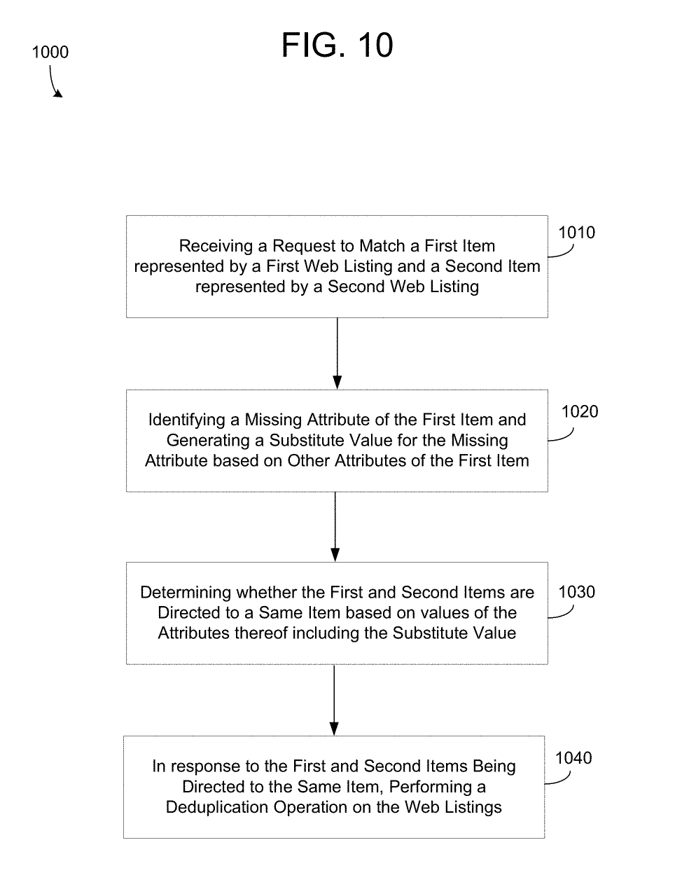

FIG. 10 illustrates a method 1000 for performing deduplication of web listings in accordance with an example embodiment. For example, the method 1000 may be performed by a web server, a database, a cloud platform, or another type of computing system or combination of systems. Referring to FIG. 10, in 1010 the method includes receiving digital content of a plurality of web listings. Here, each web listing may represent an item and may include a plurality of attributes associated with the respective item. Attributes can include characteristics or properties associated with the item and may have numerical values, text-based values, and the like. The items may include a product, a service, a hotel stay, a vacation rental property, a cruise ship rental, a rental car, an airline ticket, a train ticket, and the like. The web listings may be receive from one or more databases, web servers, cloud platforms, or other computing systems during a periodic scan or crawl of the devices via the Internet, and the like.

In 1020, the method includes receiving a request to process a first item represented by a first web listing and a second item represented by a second web listing. For example, the request may be triggered by an application requesting a deduplication operation, a user command, or the like. The processing request may trigger a matching process to be executed by the system.

In 1030, the method includes detecting an attribute of the first item that is missing from the first web listing, and determining a substitute value for the missing attribute based on a value of one or more of other attributes of the first item included in the first web listing. In some embodiments, the determining the substitute value for the missing attribute may be performed by executing a random forest modeling process with the values of the one or more other attributes as inputs. In 1040, the method may include determining whether the first and second items are directed to a same item based on values of the attributes of the first item, including the inferred value, and values of the attributes of the second item. For example, the first item and the second item may be directed to the same product, service, property listing, travel itinerary, rental car, and the like.

In 1050 the method may include, in response to determining the first and second items are directed to the same item, executing a deduplication operation based on the first and second web listings. For example, the executing of the deduplication operation may include removing at least one of the first web listing and the second web listing from an inventory which includes the plurality of web listings. As another example, the executing of the deduplication operation may include aggregating digital content from the first and second web listings, and storing the aggregated digital content as a single web listing in an inventory.

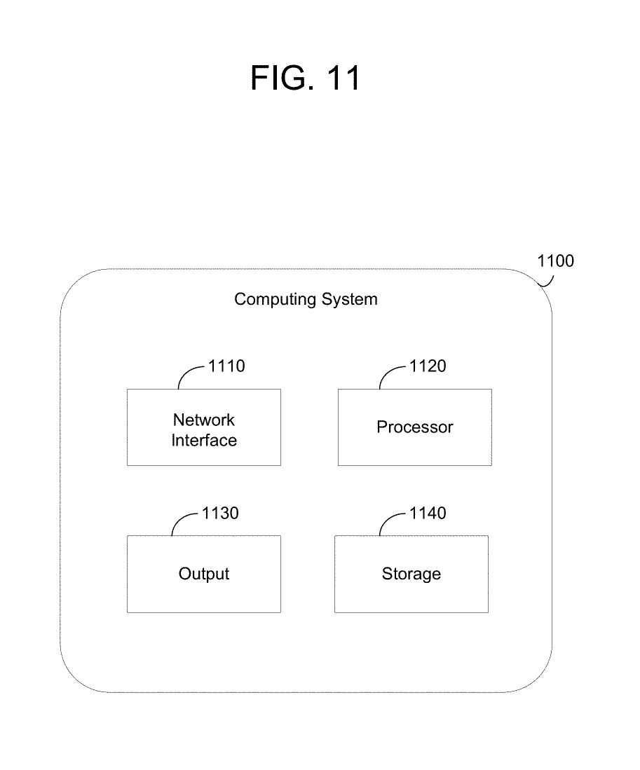

FIG. 11 illustrates a computing system 1100 in accordance with example embodiments. For example, the computing system 1100 may be a web server, a database, a cloud platform, a user device, and the like. In some embodiments, the computing system 1100 may be distributed across multiple devices. Also, the computing system 1100 may perform the methods 900 of FIGS. 9 and 1000 of FIG. 10. Referring to FIG. 11, the computing system 1100 includes a network interface 1110, a processor 1120, an output 1130, and a storage device 1140 such as a memory. Although not shown in FIG. 11, the computing system 1100 may include other components such as a display, an input unit, a receiver, a transmitter, and the like.

The network interface 1110 may transmit and receive data over a network such as the Internet, a private network, a public network, and the like. The network interface 1110 may be a wireless interface, a wired interface, or a combination thereof. The processor 1120 may include one or more processing devices each including one or more processing cores. In some examples, the processor 1120 is a multicore processor or a plurality of multicore processors. Also, the processor 1120 may be fixed or it may be reconfigurable. The output 1130 may output data to an embedded display of the computing system 1100, an externally connected display, a display connected to the cloud, another device, and the like. The storage device 1140 is not limited to a particular storage device and may include any known memory device such as RAM, ROM, hard disk, and the like, and may or may not be included within the cloud environment. The storage 1140 may store software modules or other instructions which can be executed by the processor 1120 to perform the method 900 shown in FIG. 9 and/or the method 1000 shown in FIG. 10.

According to various embodiments, the network interface 1110 may receive digital content of web listings from various content providing servers that host websites and webpages therein. The digital content may include descriptions, images, and other attributes of the items represented by the web listings. The processor 1120 may extract image points from a first image associated with a first web page and image points from a second image associated with a second web page, determine image point pairings between the image points of the first image and the image points of the second image based on content included in the images, and execute a regression operation on the image point pairs to determine which image point pairings are a match.

Furthermore, in response to an amount of matching image point pairings being greater than a predetermined threshold, the processor 1120 may determine that the first image and the second image are captured of the same item (e.g., a same hotel room, a same car, a same consumer electronic device, a same consumer product, and the like), and transmit information about the first and second images captured of the same item to an application. The application may include a deduplication application capable of removing one of the web listings based on the web listings being directed to a same item in order to reduce redundant search results. As another example, the application may include a linking application that links together data from different entities where the first web listing corresponds to a first entity data and the second web listing corresponds to a second entity data.

For example, the processor 1120 may determine image point pairings by executing a SIFT operation to detect the image point pairings between the first and second images. In addition, the processor 1120 may execute a RANSAC operation on the SIFT detected image point pairings to determine which SIFT detected image point pairings are inliers and which SIFT detected image point pairings are outliers. Here, in response to an amount of SIFT detected image point pairings being determined to be inliers exceeding the predetermined threshold, the processor 1120 may determine that the first and second images are captured of the same item. In some embodiments, the processor 1120 may execute separate RANSAC operations on X coordinates and Y coordinates, respectively, of the SIFT detected image point pairings and combine results of the separate RANSAC operations for the X axis coordinates and the Y axis coordinates to determine which SIFT detected image point pairings are inliers and which SIFT detected image point pairings are outliers.

According to various other embodiments, the network interface 1110 may receive digital content of a plurality of web listings, where each web listing represents an item and includes a plurality of attributes associated with the respective item. The processor 1120 may receive a request to process a first item represented by a first web listing and a second item represented by a second web listing, detect an attribute of the first item that is missing from the first web listing, generate a substitute value for the missing attribute based on a value of one or more of other attributes of the first item included in the first web listing, and determine whether the first and second items are directed to a same item based on values of the attributes of the first item, including the inferred value, and values of the attributes of the second item. According to various aspects, in response to determining the first and second items are directed to the same item, the processor 1120 may further execute a deduplication operation based on the first and second web listings.

In some embodiments, the processor 1120 may remove at least one of the first web listing and the second web listing from an inventory stored in the storage 1140 which includes the plurality of web listings, based on the executing of the deduplication operation.

In some embodiments, the processor 1120 may aggregate digital content from the first and second web listings and store the aggregated digital content as a single web listing in an inventory, based on the executing of the deduplication operation. In some embodiments, the processor 1120 may determine the substitute value for the missing attribute by executing a random forest modeling process which receives the values of the one or more other attributes as inputs. In some embodiments, the first web listing represents a first rental property listing and the second web listing represents a second rental property listing. In this example, the attributes of each of the first and second real property rental listings may include one or more of a geographic location, a number of rooms, a number of bathrooms, a maximum number of allowed sleeping occupants, and images, of the respective property rental.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a network interface configured to receive image data; and
a processor configured to extract image points from a first image associated with a first web page and image points from a second image associated with a second web page, determine image point pairings between the image points of the first image and the image points of the second image based on content included in the images, and execute a regression operation on the image point pairs to determine which image point pairings are a match,
wherein, in response to an amount of matching image point pairings being greater than a predetermined threshold, the processor is configured to determine that the first image and the second image are captured of the same item, and transmit information about the first and second images captured of the same item to an application.

2. The computing system of claim 1, wherein the first and second images are each captured of at least one of a room, a building, a pool, and a common area, which are included in a property rental listing of a web page.

3. The computing system of claim 1, wherein the processor is configured to determine image point pairings by executing a scale-invariant feature transform (SIFT) operation to detect the image point pairings between the first and second images.

4. The computing system of claim 3, wherein the processor is configured to execute a random sample consensus (RANSAC) operation on the SIFT detected image point pairings to determine which SIFT detected image point pairings are inliers and which SIFT detected image point pairings are outliers.

5. The computing system of claim 4, wherein, in response to an amount of SIFT detected image point pairings being determined to be inliers exceeding the predetermined threshold, the processor determines that the first and second images are captured of the same item.

6. The computing system of claim 4, wherein the processor is configured to execute separate RANSAC operations on X coordinates and Y coordinates, respectively, of the SIFT detected image point pairings and combine results of the separate RANSAC operations to determine which SIFT detected image point pairings are inliers and which SIFT detected image point pairings are outliers.

7. The computing system of claim 1, wherein the first image is included in a first item listing on the first web page and the second image is included in a second item listing on the second web page, and the first and second item listings are stored in an inventory of item listings.

8. The computing system of claim 7, wherein the processor is further configured to execute a de-duplication operation on the inventory of web listings based on determining that the first and second item listings include images that are captured of the same item.

9. A computer-implemented method comprising:
extracting image points from a first image associated with a first web page and image points from a second image associated with a second web page;
determining image point pairings between the image points of the first image and the image points of the second image based on content included in the images;
executing a regression operation on the image point pairs to determine which image point pairings are a match; and
in response to an amount of matching image point pairings being greater than a predetermined threshold, determining the first image and the second image are captured of the same item, and transmitting information about the first and second images captured of the same item to an application.

10. The computer-implemented method of claim 9, wherein the first and second images are each captured of at least one of a room, a building, a pool, and a common area, which are included in a property rental listing of a web page.

11. The computer-implemented method of claim 9, wherein the determining image point pairings comprises executing a scale-invariant feature transform (SIFT) operation to detect the image point pairings between the first and second images.

12. The computer-implemented method of claim 11, wherein the executing the regression operation comprises executing a random sample consensus (RANSAC) operation on the SIFT detected image point pairings to determine which SIFT detected image point pairings are inliers and which SIFT detected image point pairings are outliers.

13. The computer-implemented method of claim 12, wherein, in response to an amount of SIFT detected image point pairings being determined to be inliers exceeding the predetermined threshold, the determining comprises determines that the first and second images are captured of the same item.

14. The computer-implemented method of claim 12, wherein the executing the RANSAC operation comprises executing separate RANSAC operations on X coordinates and Y coordinates, respectively, of the SIFT detected image point pairings and combining results of the separate RANSAC operations to determine which SIFT detected image point pairings are inliers and which SIFT detected image point pairings are outliers.

15. The computer-implemented method of claim 9, wherein the first image is included in a first item listing on the first web page and the second image is included in a second item listing on the second web page, and the first and second item listings are stored in an inventory of item listings.

16. The computer-implemented method of claim 15, wherein the method further comprises executing a de-duplication operation on the inventory of web listings based on determining that the first and second item listings include images that are captured of the same item.

17. A non-transitory computer readable medium having stored therein instructions that when executed cause a computer to perform a method for performing deduplication of web content, the content comparison method comprising:
extracting image points from a first image associated with a first web page and image points from a second image associated with a second web page;
determining image point pairings between the image points of the first image and the image points of the second image based on content included in the images;
executing a regression operation on the image point pairs to determine which image point pairings are a match; and
in response to an amount of matching image point pairings being greater than a predetermined threshold, determining the first image and the second image are captured of the same item, and transmitting information about the first and second images captured of the same item to an application.

18. The non-transitory computer readable medium of claim 17, wherein the first and second images are each captured of at least one of a room, a building, a pool, and a common area, which are included in a property rental listing of a web page.

19. The non-transitory computer readable medium of claim 17, wherein the determining image point pairings comprises executing a scale-invariant feature transform (SIFT) operation to detect the image point pairings between the first and second images.

20. The non-transitory computer readable medium of claim 17, wherein the executing the regression operation comprises executing a random sample consensus (RANSAC) operation on the SIFT detected image point pairings to determine which SIFT detected image point pairings are inliers and which SIFT detected image point pairings are outliers.
